(19) United States
(12) Patent Application Publication
(10) Pub. No.: US 2008/0124580 A1
(43) Pub. Date: May 29, 2008

(54) Magnetic head, method of manufacturing magnetic head, and magnetic disc device

(75) Inventors: Takayuki Musashi, Kawasaki (JP); Yoshiharu Kasamatsu, Kawasaki (JP); Hiroshi Chiba, Kawasaki (JP); Jun Watanabe, Kawasaki (JP)

Correspondence Address: KRATZ, QUINTOS & HANSON, LLP, 1420 K Street, N.W., Suite 400, WASHINGTON, DC, 20005, US

(73) Assignee: FUJITSU LIMITED, Kawasaki (JP)

(21) Appl. No.: 11/819,426

(22) Filed: Jun. 27, 2007

Related U.S. Application Data
(63) Continuation of application No. PCT/JP05/00231, filed on Jan. 12, 2005.

(51) Int. Cl. G11B 5/187

(52) U.S. Cl. 428/810; 428/848.1; 427/444

(57) ABSTRACT

A magnetic disc device includes a magnetic disc, a magnetic head and an actuator. A ramp portion is provided for retracting the magnetic head when recording/reproducing operation is not performed. The ramp portion is arranged on a running path of the magnetic head on an external side of the magnetic disc so that a part of the ramp portion protrudes to an upper part of the outer periphery of the magnetic disc. A load-bar lubrication layer is formed on the surface of a load bar provided at the leading edge of the magnetic head. A head lubrication layer is formed on a head-slider plane of a head slider of the magnetic head. The load-bar lubrication layer reduces a dynamic friction coefficient with the ramp portion surface and suppresses occurrence of abrasion power, and the head lubrication layer suppresses adhesion of abrasion powder to the head-slider plane.

### CROSS-REFERENCE TO RELATED APPLICATION

This application is a U.S. continuation application which is filed under 35 USC 111(a) and claims the benefit under 35 USC 120 and 365(c) of International Application No. PCT/JP2005/000231, filed on Jan. 12, 2005, the entire contents of which are hereby incorporated by reference.

### BACKGROUND OF THE INVENTION

1. Field of the Invention

This invention relates to a ramp-load type magnetic head, a method of manufacturing the magnetic head, and a magnetic disc device provided with the magnetic head.

2. Description of the Related Art

In recent years, the amount of the information being treated increases rapidly with improvement in the high-speed communication technology, and magnetic disc devices, such as hard disc drives, have come to be extensively utilized.

The hard disc drives generally have a large storage capacity, a high recording density, and a high-speed accessing capability, and the miniaturization and weight saving thereof are improved. The use of hard disc drives in notebook type personal computers and portable terminals is increasing.

In a hard disc drive, a magnetic head performs recording/reproducing operation while the magnetic head is lifted by a very small height of ten or more nanometers from the surface of a rotating magnetic disc. When the recording/reproducing operation is not performed, the rotation of the magnetic disc is stopped and the magnetic head is settled to be in contact with the surface of the magnetic disc. However, if impact is externally applied to the hard disc device in such a state, the magnetic head hits the surface of the magnetic disc due to the impact, and the grooves and the recording layer formed in the magnetic disc will be damaged. If they are damaged, reproducing the recorded information from the magnetic disc will be impossible.

To avoid the problem, a ramp-load type magnetic head for use in a hard disc drive has been proposed. The magnetic head of this type is arranged so that, when the magnetic head is not performing recording/reproducing operation, the magnetic head is moved to a retracted position that is separate from the magnetic disc surface.

FIG. 1 shows a loading/unloading operation of a magnetic head in a ramp-load type magnetic disc device according to the related art. As shown in FIG. 1, a magnetic head 100 is lifted from the top surface of a magnetic disc 103 at a position indicated by the arrow A when it performs recording/reproducing operation.

After the recording/reproducing operation is completed, the magnetic head 100 is moved to the retracted position on the side of the outer periphery of the magnetic disc 103 (the position of the magnetic head 100 is indicated by the arrow B), and a load bar 102 provided at the leading edge of the magnetic head 100 is brought into contact with a ramp portion 104.

The magnetic head 100 is moved up with the load bar 102 contacting the inclined part of the ramp portion 104, and at the same time a head slider 101 of the magnetic head 100 is lifted from the surface of the magnetic disc 103 to an upper part, so that the magnetic head 100 is settled at a position indicated by the arrow C. In this manner, an unloading operation of the magnetic head 100 is performed.

On the other hand, when a loading operation of the magnetic head 100 is performed, the magnetic head 100 is moved down to the surface of the magnetic disc 103 with the load bar 102 contacting the ramp portion 104. And the load bar 102 is separated from the ramp portion 104, and an air bearing is formed between the head slider 101 and the surface of the magnetic disc 103 so that the magnetic head 100 is lifted over the surface of magnetic disc 103 by the air bearing.

Usually, the load bar 102 is made of a metallic material, such as stainless steel, and the ramp portion 104 is made of a resin material. At the times of loading operation and unloading operation of the magnetic head 100, the load bar 102 is moved up and down while contacting the ramp portion 104. For this reason, there is a possibility that a large number of repetitions of loading operation and unloading operation cause abrasion powder to be produced from the ramp portion 104 made of resin by sliding.

Abrasion powder adheres to the load bar 102, and when the magnetic head 100 is loaded, it falls on the surface of the magnetic disc 103. Such abrasion powder adheres to the head-slider surface of the magnetic head 100. Thus, the presence of abrasion powder or its accumulation in the space between the head-slider surface of the magnetic head 100 and the surface of the magnetic disc 103 is remarkably detrimental to the air-bearing stability of the magnetic head 100, and there is a problem that a head crash will occur finally.

To obviate the problem, various proposals have been made. For example, a magnetic disc device is proposed, wherein a slot is provided in the ramp portion so that abrasion powder may fall to the slot in the ramp portion, in order to avoid adhesion of the abrasion powder to the magnetic disc surface. For example, refer to Japanese Laid-Open Patent Application No. 2000-132937.

However, even if such countermeasure is taken, minute particles of abrasion powder enter the space where the magnetic disc and the magnetic head are accommodated. In such a case, avoiding adhesion of the abrasion powder to the surface of the magnetic disc will be impossible, and the above-mentioned problem does arise.

Moreover, another technique for avoiding adhesion of abrasion powder to the magnetic disc surface is proposed wherein minute unevenness is formed in the head-slider surface to reduce a surface energy. For example, refer to Japanese Laid-Open Patent Application No. 09-219077. However, there is a problem that use of this technique raises the manufacture cost of the head slider.

From now on, the amount of lifting height of the magnetic head will further decrease according to the increasingly high recording density of magnetic disc devices. There will be a possibility that a very small quantity of abrasion powder is the factor of reducing the air-bearing stability remarkably, and adhesion of the abrasion powder to the head-slider surface will become a serious problem.

### SUMMARY OF THE INVENTION

According to one aspect of the invention, there is provided an improved magnetic head and magnetic disc device in which the above-described problems are eliminated.

According to one aspect of the invention, there is provided a magnetic head which suppresses occurrence of abrasion power of the ramp portion by sliding and suppresses adhesion of abrasion power to the head-slider surface to attain high reliability of magnetic recording and reproducing.

According to one aspect of the invention, there is provided a magnetic disc device including a magnetic head which suppresses occurrence of abrasion power of the ramp portion by sliding and suppresses adhesion of abrasion power to the head-slider surface to attain high reliability of magnetic recording and reproducing.

According to one aspect of the invention, there is provided a method of manufacturing a magnetic head which suppresses occurrence of abrasion power of the ramp portion by sliding and suppresses adhesion of abrasion power to the head-slider surface to attain high reliability of magnetic recording and reproducing.

In an embodiment of the invention which solves or reduces one or more of the above-mentioned problems, there is provided a magnetic head for use in a ramp-load type magnetic disc device, the magnetic head including a head slider having a recording element and/or a reproducing element, and a suspension supporting the head slider, the suspension having a magnetic-head supporting part at a leading edge of the suspension, the magnetic-head supporting part contacting a ramp portion of a magnetic disc device during loading/unloading operation of the magnetic head while, the magnetic head comprising: a first lubrication layer formed on a head-slider plane where the head slider faces a magnetic disc; and a second lubrication layer formed on a surface of the magnetic-head supporting part.

The above-mentioned magnetic head may be configured so that the first lubrication layer comprises a chemical adsorption layer chemically bonded to the head-slider plane.

The above-mentioned magnetic head may be configured so that the second lubrication layer comprises a chemical adsorption layer chemically bonded to the magnetic-head supporting part.

The above-mentioned magnetic head may be configured so that at least one of the first lubrication layer and the second lubrication layer contains a lubricant molecule having an end group which is a polar group.

The above-mentioned magnetic head may be configured so that at least one of the first lubrication layer and the second lubrication layer is subjected to high energy radiation or heat treatment.

The above-mentioned magnetic head may be configured so that a surface tension of the first lubrication layer, which is determined according to Fowkes formula, is equal to or smaller than a surface tension of the head-slider plane.

The above-mentioned magnetic head may be configured so that the first lubrication layer and the second lubrication layer contain at least one of fluorine-based hydrocarbon and fluorination polyether.

The above-mentioned magnetic head may be configured so that the magnetic-head supporting part has a convex curved surface contacting the ramp portion, and the second lubrication layer is formed on said convex curved surface.

The above-mentioned magnetic head may be configured so that the first lubrication layer has a thickness which is equal to or smaller than a thickness of the second lubrication layer.

The above-mentioned magnetic head may be configured so that the second lubrication layer comprises a chemical adsorption layer and a physical adsorption layer, and a thickness of the chemical adsorption layer is in a range of 30-100% of a thickness of the second lubrication layer.

In an embodiment of the invention which solves or reduces one or more of the above-mentioned problems, there is provided a ramp-load type magnetic disc device comprising the above-mentioned magnetic head and a ramp portion which contacts the magnetic-head supporting part of the leading edge of the suspension during loading/unloading operation of the magnetic head.

In an embodiment of the invention which solves or reduces one or more of the above-mentioned problems, there is provided a method of manufacturing a magnetic head for use in a ramp-load type magnetic disc device, the method comprising steps of: assembling a suspension having a magnetic-head supporting part which contacts a ramp portion of a magnetic disc device during loading/unloading operation of the magnetic head; attaching a head slider to the suspension; and performing a lubricant application process to form a first lubrication layer on a head-slider plane of the head slider facing a magnetic disc, and form a second lubrication layer on a surface of the magnetic-head supporting part.

According to the embodiments of the magnetic head, the manufacturing method thereof and the magnetic disc device of the invention, the magnetic head includes a first lubrication layer formed on the surface of the head slider (or the head-slider plane) where the magnetic head faces the magnetic disc, and a second lubrication layer formed on the surface of the magnetic-head supporting part which contacts the ramp portion of the magnetic disc device during loading/unloading operation.

Therefore, occurrence of abrasion powder by sliding of the load bar with the surface of the ramp portion during loading/unloading operation of the magnetic head is suppressed by the second lubrication layer, and adhesion of abrasion powder to the head slider surface is suppressed by the first lubrication layer. The quantity of abrasion powder adhering to the magnetic head is reduced to a very small quantity, and deterioration of the air-bearing characteristic of the magnetic head due to the adhesion of abrasion powder is suppressed highly, thereby realizing the magnetic head with good reliability.

### BRIEF DESCRIPTION OF THE DRAWINGS

Other objects, features and advantages of the present invention will become more apparent from the following detailed description when read in conjunction with the accompanying drawings.

FIG. 1 is a diagram for explaining the problem of a magnetic head according to the related art.

FIG. 2 is a plan view of the principal part of a magnetic disc device in an embodiment of the invention.

FIG. 3 is a diagram showing an example of a magnetic disc of in-surface magnetic recording type which constitutes a part of the magnetic disc device of this embodiment.

FIG. 4 is a diagram showing an example of a magnetic disc of vertical magnetic recording type which constitutes a part of the magnetic disc device of this embodiment.

FIG. 5 is a plan view of a magnetic head in an embodiment of the invention.

FIG. 6 is a cross-sectional view of the magnetic head taken along the line A-A indicated in FIG. 5.

FIG. 7 is a diagram for explaining the structure of a load-bar lubrication layer formed on a load bar of the magnetic head.

FIG. 8A is an enlarged plan view of a head slider of the magnetic head.

FIG. 8B is a cross-sectional view of the head slider taken along the B-B indicated in FIG. 8A.

FIG. 9A is a diagram for explaining loading operation and unloading operation of the magnetic head.

FIG. 9B is a diagram for explaining loading operation and unloading operation of the magnetic head.

FIG. 10 is a flowchart for explaining a method of manufacturing the magnetic head in an embodiment of the invention.

FIG. 11A is a diagram for explaining how to apply lubricant in the raising method.

FIG. 11B is a diagram for explaining how to apply lubricant in the raising method.

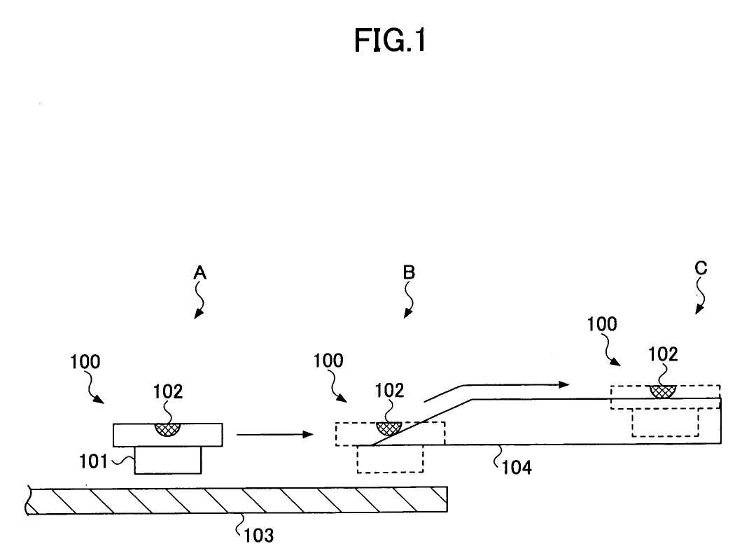

### DETAILED DESCRIPTION OF PREFERRED EMBODIMENTS

A description will now be given of the preferred embodiments of the invention As shown in the accompanying drawings.

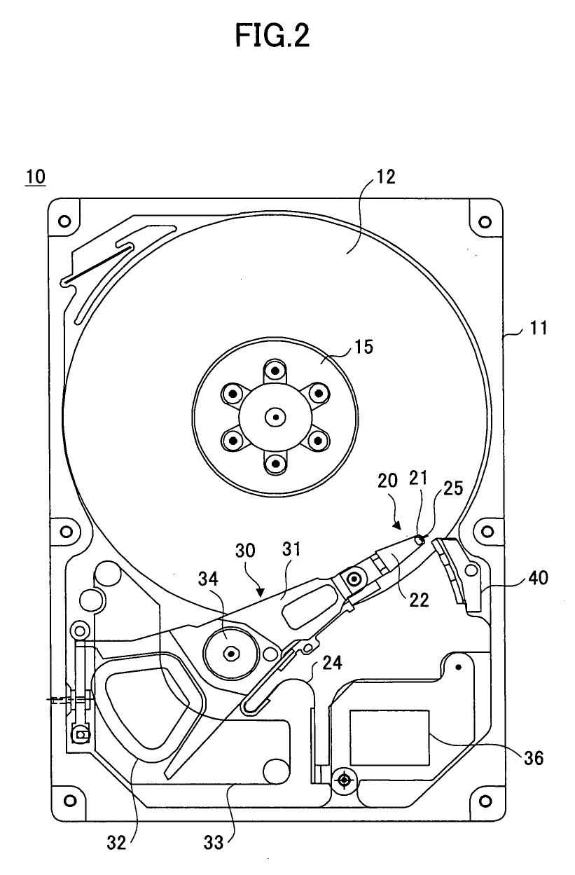

FIG. 2 shows the principal part of a magnetic disc device in an embodiment of the invention. As shown in FIG. 2, the magnetic disc device 10 generally includes a magnetic disc 12, a magnetic head 20, and an actuator 30, which are accommodated in a disc enclosure 11. The disc enclosure 11 is sealed with the top cover which is not illustrated in FIG. 2, thereby preventing inclusion of dust from the external atmosphere etc. into the magnetic disc device 10.

The magnetic disc 12 is fixed to the hub 15, and this magnetic disc 12 is rotated by a spindle motor (which is arranged on the back side of the magnetic disc 12 and not illustrated in FIG. 2) connected to the hub 15.

The magnetic disc 12 includes a disc-like substrate, and deposited on the substrate are: a magnetic layer for holding information as a direction of magnetization; a protective coating film formed on the magnetic layer surface for preventing mechanical damage, oxidization, etc. of the magnetic layer; a lubrication layer formed on the protective coating film, etc.

In a case of in-surface magnetic recording type, an in-surface magnetization film in which the magnetizing direction is parallel to the direction of the substrate surface is used as the magnetic layer. In a case of vertical magnetic recording type, a vertical magnetization film in which the magnetizing direction is at right angles to the direction of the substrate surface is used as the magnetic layer.

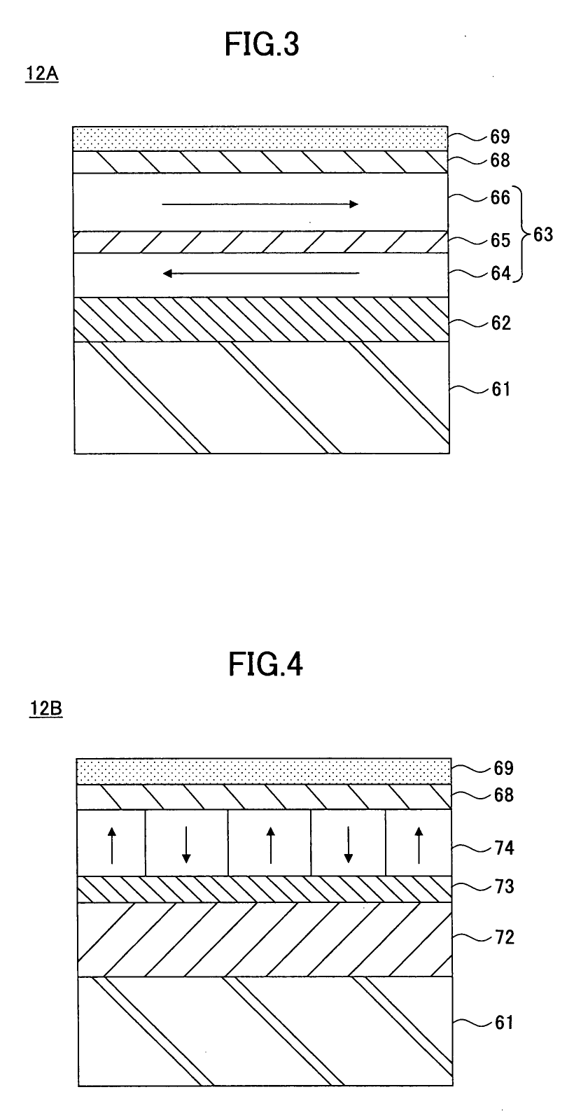

FIG. 3 shows an example of the magnetic disc of in-surface magnetic recording type which constitutes a part of the magnetic disc device of this embodiment.

As shown in FIG. 3, the magnetic disc 12A includes a disc-like substrate 61, and sequentially laminated on the substrate 61 are a primary coating layer 62, a recording layer 63, a protective coating film 68, and a lubrication layer 69.

The substrate 61 is made of any of a disc-like plastic plate, a glass substrate, a NiP plated aluminum alloy substrate, etc. The surface of the substrate 61 may be subjected to texture processing, or no texture processing may be performed to the substrate surface.

The base layer 62 is made of Cr or a Cr—X alloy (where X denotes Mo, W, V, B, Mo, or any one chosen from these alloys). The primary coating layer 62 serves to makes an orientation of magnetization of a first magnetic layer 64 and a second magnetic layer 66 of the recording layer 63, substantially parallel to the surface of the substrate 61 (which is called in-surface orientation).

The recording layer 63 includes the first magnetic layer 64, a nonmagnetic connecting layer 65, and the second magnetic layer 66. This recording layer has the switched connection structure in which the magnetization of the first magnetic layer 64 and the magnetization of the second magnetic layer 66 are switched and connected via the nonmagnetic connecting layer 65 in an anti-ferromagnetic manner, and the magnetization directions of the first magnetic layer 64 and the second magnetic layer 66 are oriented to the in-surface direction parallel to the substrate surface direction and mutually opposite in the state where an external magnetic field is not impressed. That is, the magnetic disc 12A is a synthetic ferromagnetic medium (SFM).

The first magnetic layer 64 and the second magnetic layer 66 are set to have a thickness in a range of 0.5 nm-20 nm, and made of any of Co, Ni, Fe, a Co based alloy, a Ni based alloy, a Fe based alloy, etc. In the case of a Co based alloy, CoCrTa and CoCrPt are preferred. And CoCrPt-M (where M denotes any one chosen from B, Mo, Nb, Ta, W, Cu, and the alloy thereof) is more preferred in respect of control of the particle size of crystal grain. The first magnetic layer 64 may be formed by laminating two or more layers made of such materials, in order to improve the in-surface orientation characteristic of the second magnetic layer 66.

The nonmagnetic connecting layer 65 is set to have a thickness in a range of 0.4-1.5 nm, and made of any of Ru, Rh, Ir, a Ru based alloy, a Rh based alloy, an Ir based alloy, etc.

The recording layer 63 is not limited to one having two magnetic layers laminated. It may be one having three or more magnetic layers laminated in which the magnetizations of the magnetic layers are mutually switched and connected and at least two of the magnetic layers are connected together in an anti-ferromagnetic manner. The recording layer 63 including a single magnetic layer may be used.

The protective coating film 68 is set to have a thickness in a range of 0.5-10 nm (preferably, a range of 0.5-5.0 nm), and made of any of diamond-like carbon (or hydrogenation carbon), carbon nitride, amorphous carbon, etc.

The lubrication layer 69 is set to have a thickness in a range of 0.5-3.0 nm, and made of a fluorine based lubricant containing perfluoropolyether as a principal chain and containing an end group of —CF₂CHOH, a piperonyl group, etc. Specifically, “Solvay Solexis Fomblin (registered trademark) Z-Dol (trade name)”, “AM3001 (trade name)”, etc. which will be mentioned later, may be used as the lubrication layer 69.

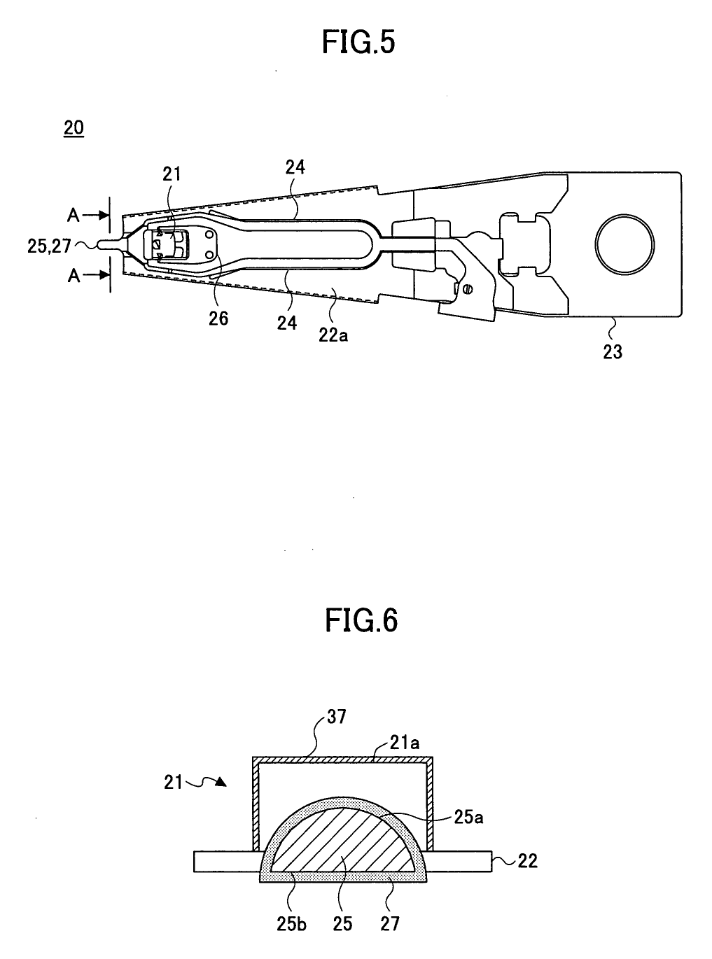

FIG. 4 shows an example of the magnetic disc of vertical magnetic recording type which constitutes a part of the magnetic disc device of this embodiment. In FIG. 4, the elements which are the same as corresponding elements in FIG. 3 are designated by the same reference numerals, and a description thereof will be omitted.

As shown in FIG. 4, the magnetic disc 12B includes a disc-like substrate 61, and sequentially laminated on the substrate 61 are a soft magnetic backing layer 72, a nonmagnetic intermediate layer 73, a recording layer 74, the protective coating film 68, and the lubrication layer 69.

The soft magnetic backing layer 72 is set to have a thickness in a range of 50 nm-2 micrometers. It is made of an amorphous or microcrystal soft magnetic alloy containing at least one kind of element chosen from Fe, Co, Ni, Al, Si, Ta, Ti, Zr, Hf, V, Nb, C, and B, or any of the soft magnetic alloys. Specifically, FeSi, FeAlSi, FeTaC, CoNbZr, CoCrNb, NiFeNb, etc. may be used as the soft magnetic backing layer 72.

The nonmagnetic intermediate layer 73 is set to have a thickness in a range of 2-30 nm, and made of a nonmagnetic substance containing any of Cr, Ru, Re, Ri, Hf, and an alloy of such metal. It is preferred that the nonmagnetic intermediate layer 73 is any of a Ru film, a RuCo film, a CoCr film, etc. and has the hcp structure.

The recording layer 74 is a vertical magnetization film having an easily magnetizing axis in a thickness direction. The recording layer 74 is set to have a thickness in a range of 3-30 nm. The recording layer 74 is made of any ferromagnetic alloy from among the group including Ni, Fe, Co, a Ni based alloy, a Fe based alloy, and a Co based alloy containing CoCrTa, CoCrPt, and CoCrPt-M (where M denotes any of B, Mo, Nb, Ta, W, Cu, and one chosen from these alloys).

Alternatively, the recording layer 74 may be composed of crystal particles in a columnar structure of the above-mentioned ferromagnetic alloy, and a nonmagnetic layer of a compound containing at least one element chosen from among Si, Al, Ta, Zr, Y, Mg (which physically separate the adjacent crystal particles of the ferromagnetic alloy) and at least one element chosen from among O, C, and N. Examples of the recording layer 74 in this case may include (CoPt)—(SiO₂), (CoCrPt)—(SiO₂), (CoCrPtB)—(MgO), etc. The magnetic particles form the columnar structure, and the nonmagnetic layer is formed so as to surround the magnetic particles. The magnetic particles are separated mutually and the interaction between the magnetic particles can be effectively suppressed or cut off, thereby reducing the medium noises.

The magnetic disc 12A of the in-surface recording type and the magnetic disc 12B of the vertical magnetic recording type are examples applicable to the magnetic disc device of this invention, and they are not necessarily restricted to these. For example, the magnetic disc of this invention may be a patterned medium in which the recording cells are separated from each other and arranged on the substrate 61.

Referring back to FIG. 2, the magnetic head 20, which will be described later in greater detail, includes a head slider 21 and a suspension body part 22 which supports the head slider 21. For example, the head slider 21 is a recording/reproducing type which is provided with both an induction type recording element for recording information and a magneto-resistance-effect type reproducing element for reproducing information. Since each of the recording element and the reproducing element is very small in size they are not illustrated in FIG. 2.

The magnetic head 20 is supported by the actuator 30 via the arm 31, and this magnetic head 20 is rotated in a radial direction of the magnetic disc 12 around the center of the shaft part 34 by an electromagnetic driving force which is generated between the VCM (voice coil motor) 32 arranged on the base of the actuator 30 and the permanent magnet 33 arranged on the upper and lower sides of the VCM 32.

The VCM-SPM (spindle motor) driver IC (integrated circuit) is arranged in the electronic substrate provided on the back side of the disc enclosure 11, and this VCM-SPM driver IC supplies a VCM driving current to the VCM 32. The moving direction and speed of the magnetic head 20 are controlled according to the direction and amplitude of the VCM driving current supplied.

A ramp portion 40 for retracting the magnetic head 20 is provided in the interior of the disc enclosure 11. When the magnetic disc device 10 does not perform recording/reproducing operation, the magnetic head 20 is moved to a retracted position in the ramp portion 40. The ramp portion 40 is arranged on the running path of the magnetic head 20 outside the outer periphery of the magnetic disc 12.

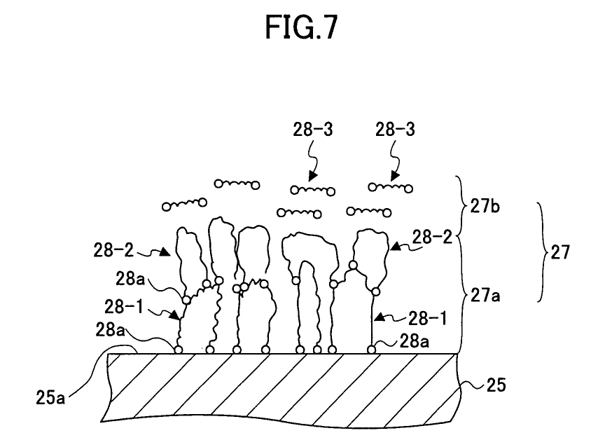

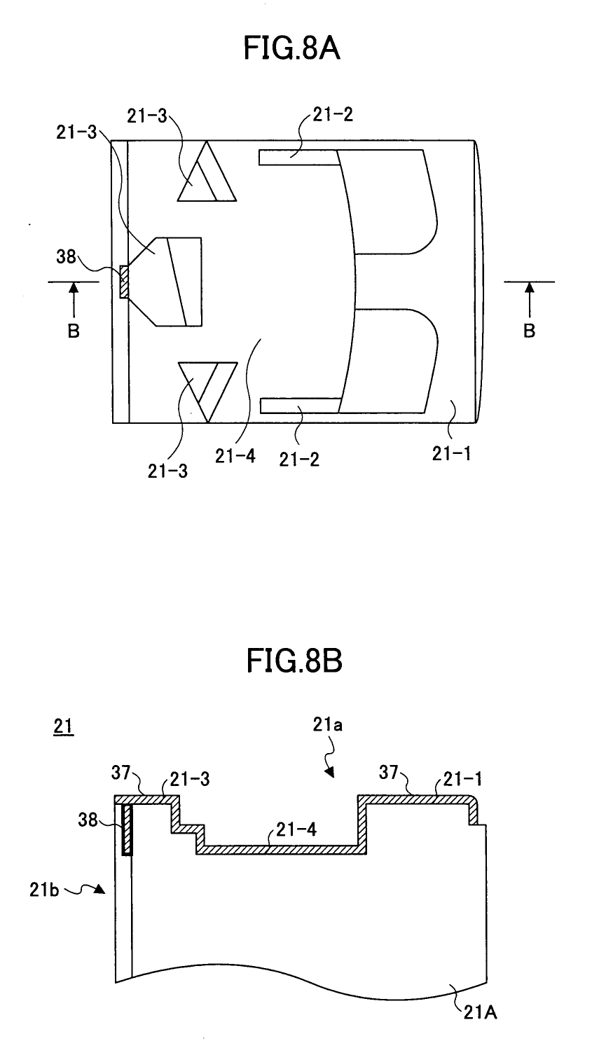

FIG. 5 is a plan view of a magnetic head in an embodiment of the invention when it is viewed from the side of the head slider. FIG. 6 is a cross-sectional view of the magnetic head of this embodiment taken along the line A-A indicated in FIG. 5.

As shown in FIG. 5 and FIG. 6, the magnetic head 20 includes a suspension body part 22a made of a sheet-like metallic material, a base plate 23 disposed on the base of the suspension body part 22a, a gimbal 26 provided at the leading edge of the suspension body part 22a, a head slider 21 fixed to the gimbal 26, and a wiring pattern 24 which connects electrically the recording element and the reproducing element of the head slider 21 and the preamplifier 36 (shown in FIG. 2). The base of the suspension body part 22a is secured to the arm 31 of the actuator 30 (shown in FIG. 2) by fitting.

For example, the suspension body part 22a is made of a metallic material, such as stainless, having a thickness of 100 micrometers. The suspension body part 22a functions as a leaf spring. That is, the suspension body part 22a generates a pressing force on the head slider 21 toward the surface of the magnetic disc 12 in accordance with a lifting force acting on the surface of the head slider 21 when the magnetic head 20 is lifted from the surface of the magnetic disc 12. With the balance of these forces, the distance between the head slider 21 and the surface of the magnetic disc 22 is uniformly maintained. The material of the suspension body part 22a may be formed of two or more metallic layers or may have a layered structure in which a resin layer is sandwiched between metallic layers, such as metallic layer/resin layer/metallic layer.

The wiring pattern 24 is formed with the necessary width on the suspension body part 22a by foils of a conductive material on the insulating resin layer made of any of polyimide resin, epoxy resin, and acrylic resin, and the surface of the wiring pattern 24 is covered with the protective layer made of polyimide resin. Alternatively, the wiring pattern 24 may be formed by a flexible printed circuit cable which is composed of a conductive material, such as copper foil, sandwiched between protective layers of polyimide resin.

The load bar 25 is provided at the leading edge of the suspension body part 22a, which is protruding outward from the leading edge of the suspension body part 22a. For example, the plan configuration of the load bar 25 is formed in the shape of a rod or a tab. At the time of performing loading/unloading operation of the magnetic head 20, the load bar 25 contacts the surface of the ramp portion 40, and the magnetic head 20 is supported by the ramp portion 40. The load bar 25 may be formed integrally with the suspension body part 22a through integral molding, or may be formed by a thin cylindrical metallic material fixed to the leading edge of the suspension body part 22a.

For example, the cross-sectional configuration of the load bar 25 is formed into a convex curved surface which is convex to the side of the head slider. With this convex curved surface, the load bar 25 can contact the ramp portion smoothly, and wearing of the ramp portion can be reduced.

The load-bar lubrication layer 27 is formed on the surface of the load bar 25. What kind of material may be used for the load-bar lubrication layer 27 as long as it is in conformity with the subject matter of this invention. However, it is preferred that the material of the load-bar lubrication layer 27 contains a fluorine based lubricant. Examples of the fluorine based lubricant may include a fluorine based hydrocarbon, a fluorination polyether, and such mixture. Especially, it is preferred to use perfluorohydrocarbon, perfluoropolyether, or such mixture. Fluorine based hydrocarbon, perfluorohydrocarbon, fluorination polyether, and perfluoropolyether may be either of straight-chain molecules or branch molecules.

It is preferred that the molecular weight of the lubricant of the load-bar lubrication layer 27 is in a range of 2000-20000 in weight average molecular weight. If the weight average molecular weight is smaller than 2000, it tends to easily disperse when forming the physical adsorption layer (which will be described later) is formed. If the weight average molecular weight is larger than 20000, the viscosity becomes too high, and there is a possibility that, when the physical adsorption layer is formed, the coefficient of dynamic friction between the load bar 25 and the ramp portion 40 may increase excessively.

For example, the structure of perfluoropolyether appropriate for the load-bar lubrication layer 27 is represented as follows.

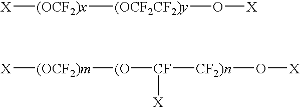

where x, y, m and n denote natural numbers, and X denotes an end group.

Examples of the end group X of the lubricant molecule may include a polar group, such as CF₂CHOH, C₆H₅, and piperonyl group, and a non-polarity group, such as trifluoromethyl group (CF₃). The lubricant application process will be described later. It is preferred to use a material of the lubricant having a molecule in which an end group is a polar group in that a firmly combined chemical adsorption layer is formed on the surface of the load bar 25 to which the lubricant is applied.

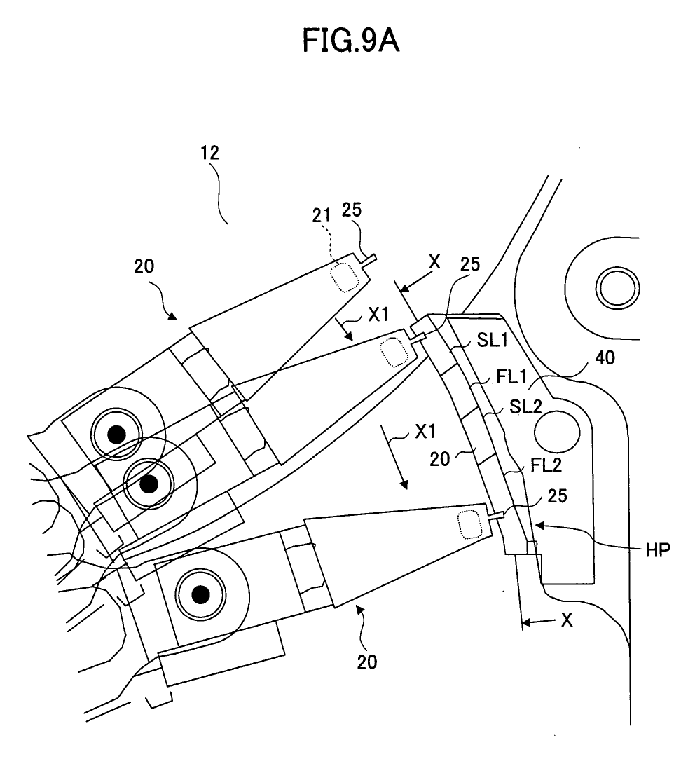

FIG. 7 is a diagram for explaining the structure of the load-bar lubrication layer 27 formed on the load bar 25. As shown in FIG. 7, the load-bar lubrication layer 27 includes a chemical adsorption layer 27a in which the molecules of the lubricant are combined with the surface 25a of the load bar 25, and a physical adsorption layer 27b in which the molecules of the lubricant are deposited on the chemical adsorption layer 27a. The chemical adsorption layer 27a includes molecules 28-1 in which end groups 28a of the molecules 28 of the lubricant are combined with the surface of the load bar 25, and molecules 28-2 which are adsorbed to the molecules 28-1. On the other hand, the physical adsorption layer 27b includes molecules 28-3 which are not combined mutually.

In the chemical adsorption layer 27a, the surface of the load bar 25 and the molecules are combined firmly. In the case of the lubricant having molecules with a polar end group, the chemical adsorption layer 27a is formed on the surface 25a of the load bar 25 only by applying the lubricant thereto. In the case of the lubricant having molecules with a non-polar end group, the molecules 28-1 combined with the surface 25a of the load bar 25 and the molecules 28-2 adsorbed to the molecules 28-1 are formed by irradiation of high energy rays after the lubricant is applied.

Alternatively, the load-bar lubrication layer 27 may be formed to include only the chemical adsorption layer 27a. In such a case, the impact of the load bar 25 when contacting the surface of the ramp portion is made to ease, and occurrence of abrasion powder by sliding of the load bar on the ramp portion can be suppressed.

It is preferred that the load-bar lubrication layer 27 has a layered structure including the chemical adsorption layer 27a and the physical adsorption layer 27b as shown in FIG. 7. By forming the load-bar lubrication layer 27 into such structure, the physical adsorption layer 27b serves to attenuate the impact, when the load bar 25 contacts the surface of the ramp portion, because the molecules to which the impact force is impressed are moved in the lateral direction. As a result, wearing of the ramp portion 30 can be reduced more effectively than the case of the load-bar lubrication layer 27 including only the chemical adsorption layer 27a, in which movement of the lubricant molecules is restricted.

It is preferred that the thickness of the load-bar lubrication layer 27 is set to be in a range of 0.5-10 nm. It is still more preferred that the thickness of the load-bar lubrication layer 27 is set to be in a range of 1.0-2.0 nm. The thickness of the lubrication layer can be measured by using any of the X-ray photoelectric spectroscopy method, the FT-IR (Fourier transform infrared spectroscopy) method, and the polarization analysis method. When a minute area, such as the load bar, is measured, it is preferred to use the microscopic FT-IR method.

It is preferred that the fixing ratio of the load-bar lubrication layer 27 (or a ratio of the thickness of the chemical adsorption layer to the thickness of the lubrication layer×100 (%)) is set to be in a range of 30-100%, and it is still more preferred that the fixing ratio is set to be in a range of 50-100%.

The thickness of the chemical adsorption layer is obtained by measuring using the above-mentioned measuring method the thickness of the chemical adsorption layer after the lubrication layer is cleaned with the solvent. The solvent used is the diluent solvent of the above-mentioned lubricant, and the cleaning of the lubrication layer is performed by immersing the load bar 25 in the solvent for one minute.

In order to form the lubrication layer which satisfies the requirement of the fixing ratio, the solvent wiping removal of the applied lubricant, or irradiation of high energy rays to the applied lubricant is performed. It is considered that a chemical bond with a lubricant molecule is formed on the surface of the load bar 25 or the chemical bond is promoted by the irradiation of high energy rays. Examples of the high energy rays used may include ultraviolet rays, excimer rays, X rays, electron rays, converging ion beams, etc.

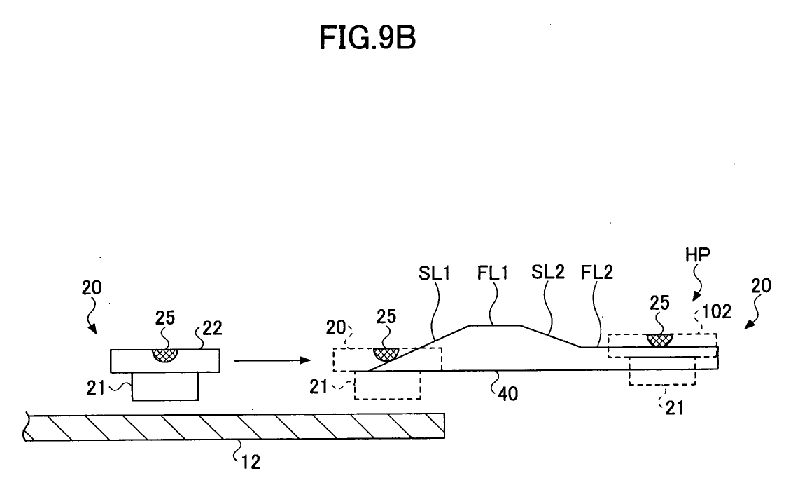

FIG. 8A is an enlarged plan view of the head slider, and FIG. 8B is a cross-sectional view of the head slider taken along the line B-B indicated in FIG. 8A. The thickness of the head lubrication layer in FIG. 8B is expanded to be larger than the size of other component parts of the head slider for the sake of convenience of description.

As shown in FIG. 8A and FIG. 8B, the head slider 21 includes a substrate 21A made of a ceramic material (for example, Al₂O₃—TiC), the reproducing element or recording element 38 (a description of the structure thereof will be omitted since the size thereof is very small) which is formed on the surface of the side of the leading edge of the magnetic head 20 through the thin film fabrication process, a convex rail 21-1, a convex rail 21-2, a pad 21-3, a cavity 21-4 (which are formed on the head-slider plane 21a), and the head lubrication layer 37 formed on the head-slider plane 21a. The rails 21-1 and 21-2, the pad 21-3, and the cavity 21-4 are provided to form with the head slider 21 an air bearing on the surface of the magnetic disc at the time of lifting of the magnetic head.

Since the head lubrication layer 37 is formed on the head-slider plane 21a, the surface free energy is reduced and the adhesion of abrasion powder to the head-slider plane 21a is suppressed. Unless otherwise specified, the head-slider plane 21a in this embodiment collectively includes the surfaces of the rail 21-1, the rail 21-2, the pad 21-3, and the cavity 21-4.

Although the ceramic material is exposed from the head-slider plane 21a, the head-slider protective coating film, such as an amorphous carbon film or a hydrogenation carbon film, may be provided in a part or the whole of the head-slider plane 21a for protection of the surface of the ceramic material.

The head lubrication layer 37 is formed on the head-slider plane 21a. When the head-slider protective coating film is provided, the head lubrication layer 37 is formed on the surface of the head-slider protective coating film. What kind of material may be used for the head lubrication layer 37 as long as it is in conformity with the subject matter of this invention. However, it is preferred that the material of the head lubrication layer 37 contains a fluorine based lubricant. Examples of the fluorine based lubricant may include a fluorine based hydrocarbon, a fluorination polyether, and such mixture. Especially, it is preferred to use perfluorohydrocarbon, perfluoropolyether, or such mixture. Fluorine based hydrocarbon, perfluorohydrocarbon, fluorination polyether, and perfluoropolyether may be either of straight-chain molecules or branch molecules.

The head lubrication layer 37 may be made of the same lubricant as the load-bar lubrication layer 27 mentioned above, and may be made of a different lubricant.

It is preferred to set the thickness of the head lubrication layer 37 to be in a range of 0.5-2.0 nm. If the thickness exceeds 2.0 nm, the distance between the head-slider plane 21a and the surface of the magnetic disc increases, which will cause the reproduction output and the S/N ratio to be lowered. If the thickness is smaller than 0.5 nm, it is difficult to cover the whole head-slider plane 21a.

As mentioned above, the end group of a molecule of the lubricant which constitutes the head lubrication layer 37 may be either a polar group, such as CF₂CHOH, C₆H₅, and piperonyl group, or a non-polarity group, such as trifluoromethyl group.

As for the lubricant molecule of the head lubrication layer 37, if the content of fluorine in one molecule is large, it is possible to make the coherence small and to form the layer uniformly, and it is possible to make the surface tension small.

It is preferred that the fluorine content is 80% or more, it is more preferred that it is 90% or more, and it is still more preferred that it is 95% or more. The fluorine content is a ratio of the molecular weight of fluorine contained in one molecule of the lubricant to the molecular weight of one molecule of the lubricant.

It is preferred that the weight average molecular weight of the lubricant of the head lubrication layer 37 is set to be in a range of 2000-20000.

Similar to the load-bar lubrication layer 27 shown in FIG. 7, the head lubrication layer 37 generally includes a chemical adsorption layer and a physical adsorption layer. Although the head lubrication layer 37 may have a physical adsorption layer, it is advisable to include the fewest possible one of the physical adsorption layer or the physically adsorbed lubricant molecule, and it is ideal that the head lubrication layer 37 includes only the chemical adsorption layer.

As mentioned above, the chemical adsorption layer is formed when the lubricant molecule having a polar end group is chemically bonded to the head-slider plane, or when the lubricant molecule having a non-polarity end group is chemically bonded to the head-slider plane by irradiation of high energy rays or heat treatment.

Since the chemical adsorption layer is firmly combined with the head-slider plane, it is difficult to shift the chemical adsorption layer to the magnetic disc surface at the time of lifting of the magnetic head and during the loading/unloading operation of the magnetic head.

It is preferred to set the fixing ratio of the head lubrication layer 37 to be in a range of 30-100%. If the fixing ratio of the head lubrication layer 37 is smaller 30% and the running test is conducted in which the magnetic head is lifted on the magnetic disc under severe environment of high temperature and high humidity (for example, 80° C. 60% RH), then a head crash easily takes place.

It is still more preferred that the fixing ratio of the head lubrication layer 37 is set to be in a range of 70-100%. In order to form the head lubrication layer 37 having such a fixing ratio, the solvent wiping removal of the applied lubricant or the irradiation of high energy rays is performed as mentioned above.

It is preferred that the head lubrication layer 37 is made of a lubricant the surface tension of which is equivalent to or smaller than the surface tension of the head-slider plane made of a ceramic material, each surface tension being determined according to Fowkes' formula. When an amorphous carbon film is formed on the head-slider plane, it is preferred that the surface tension of the head lubrication layer 37, determined according to Fowkes' formula is equivalent to or smaller than the surface tension of the amorphous carbon film. By using such lubricant, a thin head lubrication layer can be formed on the head-slider plane uniformly.

According to the inventor's consideration of this embodiment, it is confirmed that the surface tension of the head-slider plane of (Al₂O₃—TiC) according to Fowkes' formula is equal to 43 mN/m and the surface tension of the amorphous carbon film according to Fowkes' formula is equal to 32.2 mN/m. Therefore, it is preferred that the surface tension of the lubricant which forms the head lubrication layer according to Fowkes' formula is smaller than that of the material which forms the head-slider plane. Specifically, it is still more preferred that the surface tension of the lubricant is equal to or smaller than 30 mN/m.

An example of the above-mentioned lubricant may be a lubricant of perfluoropolyether in which at least one of its end groups is trifluoromethyl group. In a case of the lubricant (molecular weight: 9500) of perfluoropolyether in which both its end groups are trifluoromethyl groups, it is confirmed that the surface tension of such lubricant according to Fowkes' formula is equal to 12.8 mN/m.

The method of determining the surface tension of the lubricant according to Fowkes' formula will be explained. First, the lubricant which forms the head lubrication layer is thickly applied to a substrate, such as a silicon substrate, and a lubrication layer is formed so as to set the thickness of the lubrication layer to be in a range of 1 micrometer-several micrometers. Subsequently, a contact angle with this lubrication layer is measured using two or more kinds of liquids. Examples of the suitable liquid may include water, di-iodine methane (CH₂I₂), formamide (CH₃NO), etc. Subsequently, the surface tension of the lubricant is determined according to Fowkes' formula using the measured contact angle.

Fowkes' formula is represented as follows. Supposing that γ_{S} denotes a surface free energy of a solid sample, γ_{L} denotes a surface free energy of a liquid sample, θ_{SL} denotes a contact angle of the solid sample and the liquid sample, and γ_{SL} denotes an interface energy of the solid sample and the liquid sample, the Young's formula is obtained as in the following formula ( )

γ_{S}=γ_{L}·cos θ_{SL}+γ_{SL} (1)

### The adhesion work W_{SL} which is the energy stabilized when the liquid adheres to the solid surface is to follow Dupre's formula as in the following formula (2).

γ_{S}+γᵣ=W_{SL}+γ_{SL} (2)

### The following formula (3) which is called Young-Dupre's formula is derived from the above-mentioned formulas (1) and (2).

W_{SL}=γ_{L}(1+cos θ_{SL}). (3)

This shows that the adhesion work W_{SL} can be determined from the surface free energy of the liquid and the contact angle. If the geometrical mean rule of each component of the surface energy is applied to this adhesion work, the following formula (4) is obtained.

W_{SL}=2√(γ_{S}^{d}·γ_{L}^{d})+2√(γ_{S}^{h}·γ_{L}^{h}). (4)

where d and h denote a variance component and a hydrogen bond component respectively.

If two kinds of liquids (i, j) are used, the following relational expression (5) about the adhesion work will be obtained.

$$( \begin{matrix}{W}_{SL}^{i} \\ {W}_{SL}^{j}\end{matrix} ) = 2 ( \begin{matrix}\sqrt{{γ}_{L}^{d , i}} & \sqrt{{γ}_{L}^{h , i}} \\ \sqrt{{γ}_{L}^{d , j}} & \sqrt{{γ}_{L}^{h , j}}\end{matrix} ) ( \begin{matrix}\sqrt{{γ}_{S}^{d}} \\ \sqrt{{γ}_{S}^{h}}\end{matrix} ) \qquad ( 5 )$$

Therefore, using two kinds of liquids (i, j), the contact angle of each liquid and the solid sample is actually measured, the adhesion work W_{SL}ⁱ and the adhesion work W_{SL}^{j} are obtained, and it is possible to determine the surface free energy of the solid for every component in accordance with the following relational expression (6). As a result, the surface free energy, i.e., the surface tension of the solid sample: r=γ^{d}+γ^{h} can be determined. This relational expression is called Fowkes' formula.

$$( \begin{matrix}\sqrt{{γ}_{S}^{d}} \\ \sqrt{{γ}_{S}^{h}}\end{matrix} ) = \frac{1}{2} {( \begin{matrix}\sqrt{{γ}_{L}^{d , i}} & \sqrt{{γ}_{L}^{h , i}} \\ \sqrt{{γ}_{L}^{d , j}} & \sqrt{{γ}_{L}^{h , j}}\end{matrix} )}^{- 1} ( \begin{matrix}{W}_{SL}^{i} \\ {W}_{SL}^{j}\end{matrix} ) \qquad ( 6 )$$

Next, the loading operation and unloading operation of the magnetic head will be explained.

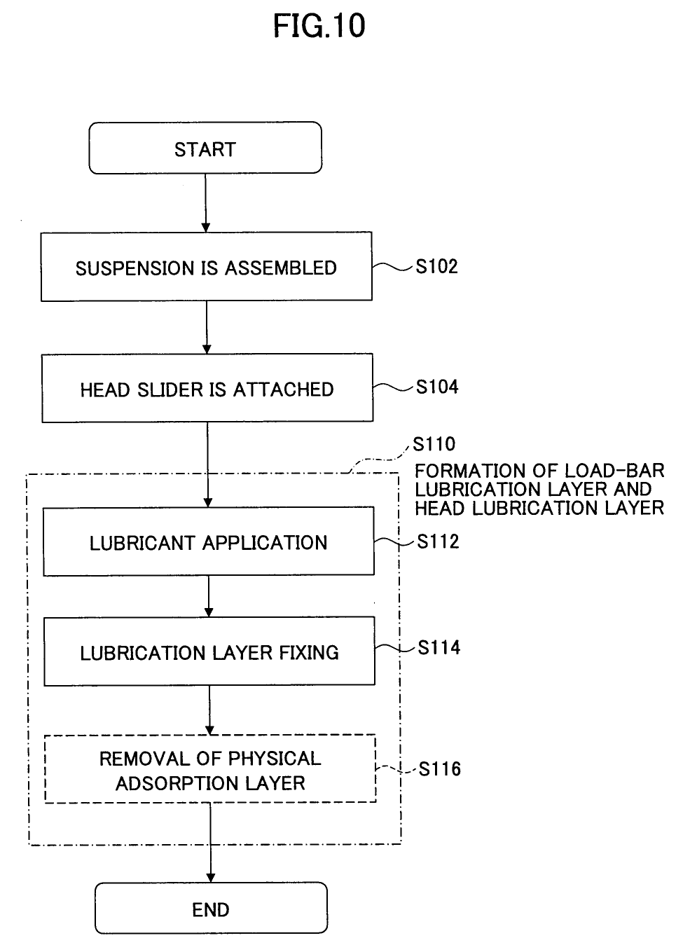

FIG. 9A and FIG. 9B are diagrams for explaining the loading operation and the unloading operation of the magnetic head. FIG. 9A is a plan view of the magnetic head, and FIG. 9B is a cross-sectional view of the magnetic head along the moving path (indicated by the line X-X in FIG. 9A).

As shown in FIG. 9A and FIG. 9B, the ramp portion 40 includes a first inclined part SL1 protruding over the outer periphery of the magnetic disc 12, a first flat part FL2 extending from the first inclined part SL1, a second inclined part SL2 extending from the first flat part FL2, and a second flat part FL2 extending from the second inclined part SL2.

Upon start of the unloading operation, the magnetic head 20 in the state in which it is lifted over the surface of the magnetic disc 12 is moved (in the direction of the arrow X1) to the outer perimeter side of the magnetic disc, so that the load bar 25 contacts the first inclined part SL1 and is further moved up along the first inclined part SL1 of the ramp portion 40.

And the state where the air bearing is formed between the head slider 21 of the magnetic head 20 and the surface of the magnetic disc 11 is canceled. While the load bar 25 contacts the first flat part FL1 and the second inclined part SL1, the magnetic head 20 is further moved and stops at the home position HP of the second flat section FL2.

Upon start of the loading operation, the magnetic head 20 is moved, in the direction opposite to that in the unloading operation, from the home position HP to the first inclined part SL1 while the load bar 25 contacts the second flat part FL2, the second inclined part SL2, the first flat part FL1, and then the first inclined part SL1.

And the state where the air bearing is formed between the surface of magnetic disc 12 and the head-slider plane 21a is established at the first inclined part SL1, and at the same time, the load bar 25 is separated from the first inclined part SL1.

In this manner, during the loading operation and the unloading operation of the magnetic head 12, the load bar 25 contacts the surface of the ramp portion 40, and the sliding between the load bar 25 and the ramp portion 40 takes place. Since the ramp portion 40 is made of resin, it is more easily worn out than the load bar 25. Especially, the load bar 25 collides to the first inclined part SL1 of the ramp portion 40 firmly, and wearing of the surface of the first inclined part SL1 is expected.

However, in this embodiment of the invention, the load-bar lubrication layer 27 is formed on the surface of the load bar 25, and a coefficient of friction with the surface of the ramp portion 40 can be reduced, and occurrence of abrasion powder can be suppressed. It would be adequate if the load-bar lubrication layer 27 is formed only on the surface of the load bar 25 on the side of the head slider 21 (or, the surface 25a indicated in FIG. 6) which slides on the ramp portion 20.

The magnetic head which performs recording/reproducing operation to the back surface side of the magnetic disc 12 is arranged in the reversed state where the upper and lower sides are opposite to the magnetic head shown in FIG. 8B, and similarly the ramp portion is arranged in the reversed state where the upper and lower sides are opposite.

Therefore, also in this case, the surface of the load bar 25 on the side of the head slider 21 contacts the surface of the ramp portion 40. It would be adequate if the load-bar lubrication layer 27 is formed only on the surface 25a of the load bar 25 on the side of the head slider 21.

Moreover, the load-bar lubrication layer 27 which is the same as that on the load bar 25 may be formed on the surface of the ramp portion 40. Such composition allows a coefficient of friction between the surfaces of the ramp portion 40 and the load bar 25 to be reduced further, and occurrence of abrasion powder can be further suppressed.

Since the head lubrication layer is formed on the head-slider plane of the magnetic head, even if abrasion powder is created a little, adhesion of the abrasion powder is suppressed, and as a result a stabilized air-bearing characteristic of the magnetic head can be retained.

According to this embodiment, the load-bar lubrication layer 27 is formed on the surface of load bar 25, and occurrence of abrasion powder by sliding of the load bar 25 with the surface of the ramp portion 40 during loading/unloading operation of the magnetic head 20 can be suppressed. Since the head lubrication layer is formed on the head-slider plane, adhesion of abrasion powder is suppressed and an adequately reliable magnetic disc device can be realized.

If the load-bar lubrication layer 27 in this embodiment includes the chemical adsorption layer and the physical adsorption layer, the coefficient of dynamic friction of the load bar 25 with the surface of the ramp portion 40 can be reduced further, and occurrence of abrasion powder can be suppressed further.

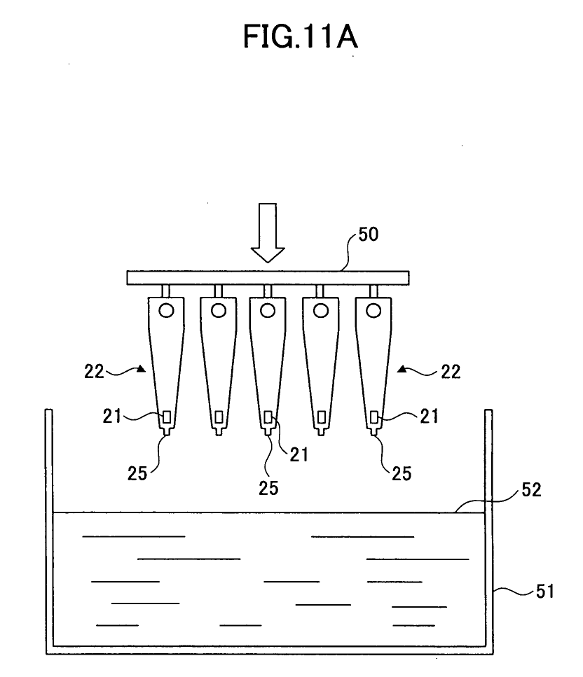

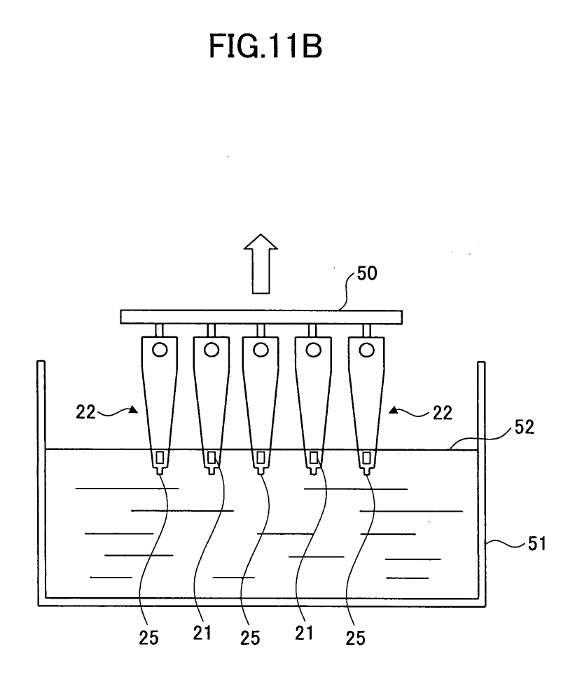

Next, the method of manufacturing the magnetic head of this embodiment will be explained. FIG. 10 is a flowchart for explaining the manufacturing process of the magnetic head. The following description will be given with reference to FIG. 5, FIG. 6 and FIG. 11 in addition to FIG. 10.

Upon start of the manufacturing process of FIG. 10, the assembly of a suspension is performed (S102). Specifically, a suspension body part 22a as shown in FIG. 5 is molded by punch processing etc. And when the load bar 25 is formed through integral molding, the load bar 25 is formed at this time.

On the other hand, when the load bar 25 is formed from a component separate from the suspension body part 22a, the load bar 25 is attached to the leading edge of the suspension body part 22a.

Subsequently, the base plate 23 is attached to the base of the suspension body part 22a, and the gimbal 26 is attached to the leading edge of the suspension. The sequence of attaching the load bar 25, the base plate 23, and the gimbal 26 is arbitrarily selected. Subsequently, the wiring pattern 24 is formed or attached to the suspension body part 22a.

Subsequently, the separately formed head slider is attached to the gimbal 26 of the suspension body part 22a (S104). The head slider 21 is produced by forming the magnetoresistance-effect type element and the induction type recording element on the wafer of (Al₂O₃—TiC) through the semiconductor process, dicing such wafer into individual head sliders 21, and performing processing of the air bearing surface 21a of the head slider 21. Subsequently, the connection between the wiring pattern 24 and the electrodes (not illustrated) of the head slider 21 is performed.

Subsequently, the load-bar lubrication layer 27 and the head lubrication layer are formed on the surface of the load bar 25 and the surface of the head-slider plane 21a, respectively (S110).

The processing of forming the load-bar lubrication layer 27 and the head lubrication layer includes the lubricant application processing (S112), the lubrication layer fixing processing (S114), and the solvent wiping removal (S116) of the physical adsorption layer from the lubrication layer which is performed, if needed.

In the lubricant application processing (S112), the lubricant diluting solution is prepared, and the lubricant diluting solution is applied to the load bar and the head-slider plane by using any of the raising method, the spraying method, the fluid surface descending method, etc. The lubricant diluting solution is prepared by diluting the lubricant using a diluent fluid: for example, “3M Novec (registered trademark) HEF (trade name)” or “DuPont Vertrel (registered trademark) XF (trade name)”.

There is no specific limitation of the lubricant if it is a lubricant having a molecule containing a principal chain of perfluoropolyether (PFPE). Examples of the lubricant used in which an end group has polarity may include “Solvay Solexis Fomblin (registered trademark) Z-Dol (trade name)” (end group: —CF₂CHOH) or “AM3001 (trade name)” (end group: piperonyl group). Examples of the lubricant used in which an end group has no polarity may include “Solvay Solexis Fomblin (registered trademark) Z15, Z25, Y25, YR1800 (trade names)” (end group: —CF₃).

In the lubricant application processing, any of the load-bar lubrication layer 27 and the head lubrication layer 37 may be formed first. When the raising method which is a commonly used lubricant application method is used, the magnetic head is hung on a holding member. In such a case, it is easier to hang the magnetic head with the load bar being placed in the lower position and apply the lubricant to the head to form a head lubrication layer first, and subsequently form a load-bar lubrication layer.

Alternatively, the magnetic head may be hung with the load bar being placed in the upper position. For example, in a case where a head lubrication layer and a load-bar lubrication layer are formed simultaneously, or in a case where a head lubrication layer and a load-bar lubrication layer are formed separately and only the head lubrication layer is formed first, the magnetic head may be hung with the load bar being placed in the upper position.

FIG. 11A and FIG. 11B are diagrams for explaining how to apply the lubricant in the raising method.

As shown in FIG. 11A, the assembled suspension 22 is hung on the fixture 50 which is raised or lowered at a predetermined speed with the load bar 25 being placed in the lower position, so that the suspension 22 is fixed to the fixture 50. At this time, it is preferred to fix a group of suspensions 22 to the fixture 22, so that the height of each suspension 22 is the same and the attitude of each suspension 22 is in the perpendicular direction.

As shown in FIG. 11B, an application bath 51 is filled up with a lubricant diluting solution 52 in which the lubricant for head sliders is diluted. An example of the lubricant used in this embodiment is a perfluoropolyether in which both the end groups are trifluoromethyl group which has no polarity.

Subsequently, the head slider 21 is lowered with the fixture 50 so that the whole head slider 21 is immersed to its height in the lubricant diluting solution 52. The immersion is held for a predetermined time, and subsequently the head slider 21 is raised with the fixture 50 from the lubricant diluting solution 52 at the predetermined speed. In this manner, the head lubrication layer is formed on the head-slider plane.

It is preferred to set the concentration of the lubricant diluting solution 52 and the raising speed so that the thickness of the head lubrication layer 37 after the evaporation of the solvent is in a range of 0.5-2.0 nm. The concentration of the lubricant in the lubricant diluting solution 52 is set to be about 0.2% by weight.

When the head lubrication layer 37 is formed, a load-bar lubrication layer will also be simultaneously formed on the load bar 25. Since both the end groups of the lubricant for head sliders are trifluoromethyl group which has no polarity, the load-bar lubrication layer may be formed by immersing it in the above-mentioned solvent.

When a lubricant having a polar end group is used as the lubricant for head sliders, a chemical adsorption layer is formed, and this chemical adsorption layer cannot be removed easily. In this case, a resist film etc. is beforehand formed on the load bar 25, and this resist film is removed after the lubricant is applied. Of course, such a procedure is unnecessary when the same lubricant is used for the head lubrication layer and the load-bar lubrication layer.

Subsequently, the lubricant is applied to the surface of the load bar 25 to form a load-bar lubrication layer. The application of the load bar lubricant is performed similar to the formation of the head lubrication layer 37 except for only the load bar 25 being immersed in the lubricant diluting solution 52.

However, it is necessary to set up the lubricant concentration of the lubricant in the lubricant diluting solution and the raising speed, so that the thickness of the resulting load-bar lubrication layer 27 is in a predetermined range.

Subsequently, the lubrication-layer fixing process (S114) is performed for the head lubrication layer and the load-bar lubrication layer which are obtained in the above processing. Specifically, the processing of heat treatment, UV irradiation treatment, or electron beam irradiation is performed to achieve the lubrication-layer fixing process.

In a case of the heat treatment processing, the suspension 22 in which the lubrication layer is formed on the load bar is heated in a range of 80-200 degrees C., using an oven or a furnace.

When a lubricant having a molecule in which the end group has polarity is used, heating the lubrication layer causes the physical adsorption layer to be turned into a chemical adsorption layer, so that the thickness of the chemical adsorption layer can be increased. When a lubricant having a molecule in which the end group has no polarity is used, an adsorption site is formed on the load bar surface and in the molecules, and, the molecules of the lubricant are rigidly joined to the load bar surface and the molecules.

In a case of the UV irradiation treatment processing, the suspension in which the lubrication layer is formed on the load bar is irradiated by UV rays of a high illuminance using a mercury lamp or an excimer vacuum UV lamp. The surface of the load bar is activated by applying the ultraviolet rays, the adsorption site of the molecules of the lubricant can be increased and the thickness of the chemical adsorption layer can be increased. Since the excimer vacuum UV lamp, especially a xenon excimer lamp using xenon gas, emits vacuum ultraviolet light with a high-intensity wavelength of 172 nm, the lubrication-layer fixing process can be performed efficiently. However, for the purpose of suppression of ultraviolet light decaying, this processing must be performed within the container in the vacuum atmosphere.

In a case of the electron beam irradiation processing, an electron beam, having an acceleration voltage of 10 kV, for example, is emitted by an electron gun, and the lubrication layer 26 of the load bar is irradiated by the electron beam within the container in the vacuum atmosphere.

Similar to the UV irradiation processing, the surface of the load bar which is irradiated by the electron beam is activated, and the adsorption site of the molecules of the lubricant can be increased, and the thickness of the chemical adsorption layer can be increased. Alternatively, a laser beam irradiation of ultraviolet or infrared rays may be used instead.

In the UV irradiation processing and the electron beam processing, the head lubrication layer 37 and the load-bar lubrication layer may be processed separately. When irradiating one of the two layers, a shielding member may be used so as to avoid irradiating the other layer.

Subsequently, the solvent wiping removal of the physical adsorption layer from the lubrication layer is performed, if needed (S116). Specifically, in the solvent wiping removal of the physical adsorption layer, the suspension is immersed in the above-mentioned solvent, subsequently the suspension is taken out from the solvent, and it is dried by natural evaporation. By this processing, the physical adsorption layer is removed from the lubrication layer. By the removal of the physical adsorption layer, it is possible to form a lubrication layer which does not disperse easily at the time of performing the loading/unloading operation. After the manufacturing process of FIG. 10 is completed, the magnetic head of this embodiment is produced.

According to the manufacturing method of this embodiment, it is possible to form the lubrication layers on the load bar surface and the head-slider plane of the suspension and reduce the coefficient of dynamic friction between the load bar and the ramp portion. And occurrence of abrasion powder by sliding of the load bar on the ramp portion can be suppressed, and adhesion of abrasion powder to the head-slider plane can be suppressed.

Some specific examples of combinations of the load-bar lubrication layer and the head lubrication layer will be described. However, this invention is not limited to the following specific examples.

### EXAMPLE 1

The head lubrication layer is formed as follows. A lubricant in which the principal chain is a straight chain of perfluoropolyether and the end groups are trifluoromethyl groups is used, and the lubricant is diluted by 2,3-dihydrodecafluoropentane, and a head lubrication layer having a thickness of 1.5 nm is formed by using the raising method (or the immersing method).

Subsequently, the head lubrication layer is irradiated for several seconds using the excimer vacuum UV lamp as the fixing processing, and the head lubrication layer having a thickness of 1.5 nm and a fixing ratio of 90% is formed.

The load-bar lubrication layer is formed as follows. The lubricant is applied to the load-bar surface simultaneously with the head lubrication layer, and the fixing processing is performed for the two layers simultaneously. The load-bar lubrication layer having a thickness of 1.5 nm and a fixing ratio of 90% is formed.

### EXAMPLE 2

After the fixing processing is performed to the head lubrication layer and the load-bar lubrication layer of the above Example 1, the layers are immersed in a solvent, such as 2,3-dihydrodecafluoropentane, for several minutes, and the physical adsorption layer is removed. In this manner, the head lubrication layer and the load-bar lubrication layer, which have a thickness of 1.3 nm and a fixing ratio of 100% (or containing only the chemical adsorption layer), are formed.

### EXAMPLE 3

The head lubrication layer is formed as follows. A lubricant in which a principal chain is a straight chain of perfluoropolyether and the end groups are —CF₂CHOH is used, the lubricant is diluted by 2,3-dihydrodecafluoropentane, and the diluted lubricant is applied by using the raising method (or the immersing method). A head lubrication layer having a thickness of 1.3 nm and a fixing ratio of 85% is formed.

The load-bar lubrication layer is formed as follows. The lubricant is applied to the load-bar surface simultaneously with the head lubrication layer. A load-bar lubrication layer having a thickness of 1.3 nm and a fixing ratio of 85% is formed.

### EXAMPLE 4

The head lubrication layer of the above Examiner 3 is irradiated by an electron beam (for example, acceleration voltage of 10 kV) for 5 seconds as the fixing processing. At this time, a shielding member is attached to the load-bar lubrication layer so as to avoid irradiation of the electron beam to the load-bar lubrication layer. In this manner, a head lubrication layer having a fixing ratio of 100% is formed. The load-bar lubrication layer is the same as that of the above Example 3.

This invention is not limited to the above-described embodiments, and variations and modifications may be made without departing from the scope of this invention. For example, in the above-mentioned embodiment, the magnetic head for use in a magnetic disc device of the air-bearing type in which the magnetic head is completely lifted from the surface of a magnetic disc has been explained as an example. However, this invention is applicable also to a magnetic disc device of the air-liquid mixture type in which a part of the head slider contacts the fluid lubrication layer of a magnetic disc and a part of the head slider is lifted from the magnetic disc surface when recording/reproducing operation is performed, and to a magnetic disc device of the contact type in which a part or the whole of the head slider contacts a magnetic disc when recording/reproducing operation is performed.

What is claimed is:

1. A magnetic head for use in a ramp-load type magnetic disc device, including a head slider having a recording element and/or a reproducing element, and a suspension supporting the head slider, the suspension having a magnetic-head supporting part at a leading edge of the suspension, the magnetic-head supporting part contacting a ramp portion of a magnetic disc device during loading/unloading operation of the magnetic head, the magnetic head comprising:
a first lubrication layer formed on a head-slider plane where the head slider faces a magnetic disc; and
a second lubrication layer formed on a surface of the magnetic-head supporting part.

2. The magnetic head according to claim 1, wherein the first lubrication layer comprises a chemical adsorption layer chemically bonded to the head-slider plane.

3. The magnetic head according to claim 1, wherein the second lubrication layer comprises a chemical adsorption layer chemically bonded to the magnetic-head supporting part.

4. The magnetic head according to claim 1, wherein at least one of the first lubrication layer and the second lubrication layer contains a lubricant molecule having an end group which is a polar group.

5. The magnetic head according to claim 1, wherein at least one of the first lubrication layer and the second lubrication layer is subjected to high energy radiation or heat treatment.

6. The magnetic head according to claim 1, wherein a surface tension of the first lubrication layer, which is determined according to Fowkes formula, is equal to or smaller than a surface tension of the head-slider plane.

7. The magnetic head according to claim 1, wherein the first lubrication layer and the second lubrication layer contain at least one of fluorine-based hydrocarbon and fluorination polyether.

8. The magnetic head according to claim 1, wherein the magnetic-head supporting part has a convex curved surface contacting the ramp portion, and the second lubrication layer is formed on said convex curved surface.

9. The magnetic head according to claim 1, wherein the first lubrication layer has a thickness which is equal to or smaller than a thickness of the second lubrication layer.

10. The magnetic head according to claim 1, wherein the second lubrication layer comprises a chemical adsorption layer and a physical adsorption layer, and a thickness of the chemical adsorption layer is in a range of 30-100% of a thickness of the second lubrication layer.

11. A ramp-load type magnetic disc device comprising:
the magnetic head according to claim 1; and
a ramp portion which contacts the magnetic-head supporting part of the leading edge of the suspension during loading/unloading operation of the magnetic head.

12. The magnetic disc device according to claim 11, wherein the ramp portion comprises a third lubrication layer formed on a surface of the ramp portion.

13. The magnetic disc device according to claim 11, wherein the head slider performs recording/reproducing operation by using one of a group of types including an air-bearing type, an air-liquid mixture type and a contact type.

14. A method of manufacturing a magnetic head for use in a ramp-load type magnetic disc device, comprising steps of:
assembling a suspension having a magnetic-head supporting part which contacts a ramp portion of a magnetic disc device during loading/unloading operation of the magnetic head;
attaching a head slider to the suspension; and
performing a lubricant application process to form a first lubrication layer on a head-slider plane of the head slider facing a magnetic disc, and form a second lubrication layer on a surface of the magnetic-head supporting part.

15. The method of manufacturing the magnetic head according to claim 14, wherein the lubricant application process is performed by applying a first lubricant to an air bearing surface of the head slider and subsequently applying a second lubricant to the surface of the magnetic-head supporting part.

16. The method of manufacturing the magnetic head according to claim 15, wherein the first lubricant is applied to the air bearing surface of the head slider and the surface of the magnetic-head supporting part simultaneously.

17. The method of manufacturing the magnetic head according to claim 15, wherein the first lubricant is the same as the second lubricant, and the lubricant application process is performed by applying the first lubricant to the air bearing surface of the head slider and the surface of the magnetic-head supporting part simultaneously.

18. The method of manufacturing the magnetic head according to claim 15, further comprising a step of performing, after the lubricant application process is performed, a fixing process to heat the first lubrication layer and/or the second lubrication layer.

19. The method of manufacturing the magnetic head according to claim 15, further comprising a step of performing, after the lubricant application process is performed, a fixing process to subject the first lubrication layer and/or the second lubrication layer to high energy radiation.

20. The method of manufacturing the magnetic head according to claim 19, wherein the high energy radiation is any one of an ultraviolet ray, an X-ray, an electron ray and a converging ion beam.

21. The method of manufacturing the magnetic head according to claim 15, further comprising a step of performing, after the lubricant application process or a fixing process is performed, a cleaning process to clean the first lubrication layer and/or the second lubrication layer with a solvent.
